(19) United States
(12) Patent Application Publication
(10) Pub. No.: US 2025/0338355 A1
(43) Pub. Date: Oct. 30, 2025

(54) SIMULTANEOUS TERAHERTZ IMAGING, INFORMATION, AND POWER TRANSFER (STIIPT)

(71) Applicant: THE GEORGE WASHINGTON UNIVERSITY, Washington, DC (US)

(72) Inventors: Milos DOROSLOVACKI, Washington, DC (US); Adnan HANIF, Arlington, VA (US)

(73) Assignee: THE GEORGE WASHINGTON UNIVERSITY, Washington, DC (US)

(21) Appl. No.: 18/650,485

(22) Filed: Apr. 30, 2024

(51) Int. Cl. H02J 50/27; H02J 50/00; H02J 50/80

(52) U.S. Cl. CPC H04W 92/00; H02J 50/27

(57) ABSTRACT

A base station of a simultaneous THz imaging, information, and power transfer (STIIPT) system, transmitting a plurality of pulsed THz waveforms to transfer both power and information to user-equipment located in the far-field, as well as estimate the range of the user-equipment when the reflected waveform is received at the base station receiver.

### BACKGROUND

### I. Introduction

Future 6G and beyond networks are expected to realize an Internet-of-Everything (IoE) vision where a myriad of devices communicate at an unprecedented rate exploiting the ultra-wide bandwidth available at Terahertz (THz) band (0.1-10 THz). Paving a way towards this IoE vision, THz systems support high link directionality and can be achieved in much smaller footprints [1]. Nevertheless, these millimeter-scale devices may not have the space or power budget to carry a battery or to conduct massive computations onboard [2]. Besides, these devices can be highly mobile in many next-generation wireless networks, such as miniature drone networks, unmanned aerial vehicle (UAV) base stations, and vehicle-to-everything (V2X) communications. This mobility necessitates imaging of transmitter vicinity and precise positioning of the target receiver for beamforming to minimize THz propagation loss [3]. To address these issues, THz system design in future wireless networks should meet their information, energy, and imaging demands simultaneously.

Traditional energy harvesters in the THz band are realized using piezoelectric nanogenerators. However, with the recent advancements in high-frequency diodes and antenna design, millimeter-scale rectennas are being proposed and manufactured to harvest energy wirelessly, [4]. GaAs Schottky diodes continue to bridge the so-called ‘THz band gap’ as one of the most useful THz detectors [5]. Operating as high as 3 THz frequencies, Schottky diodes are often fabricated with integrated antenna designs using CMOS technology to achieve compact rectennas (antenna with THz rectifying diode). A vast amount of research on rectenna's harvesting efficiency can be found in the RF literature [7]. Due to non-linear nature of rectenna, [8], [9] showed that the amount of harvested DC power is not only a function of rectenna design and signal power but is also a function of signal shape. In [8] and subsequent works, a simple rectenna model based on diode non-linearity is presented by the Taylor series expansion of diode characteristic truncated up to fourth-order term. This non-linearity is later exploited using signals having a high peak-to-average power ratio to improve harvested DC power.

Recent works on simultaneous wireless information and power transfer (SWIPT) which use RF bands transmission employ an integrated receiver (IntRx) architecture, first proposed in [10], to jointly implement information decoder (ID) and energy harvester (EH). In the IntRx design, a complete incoming signal is first rectified into a DC output which is followed by information decoding using rectified signals' amplitudes. Since the rectifying process is similar to envelop detection, the receiver does not require energy-consuming components for down-conversion making it suitable for simple IoE devices. Many pulse-based modulation schemes involving IntRx architecture for SWIPT in RF are proposed, such as pulse energy modulation (PEM) [10], dual amplitude-shift keying (ASK) [11], on-off keying (OOK) [12], and pulse-position modulation (PPM) [13]. Similarly, in the THz band for communication only, many of these pulse-based modulation schemes are also extensively being studied to achieve tens of Gbps data rate [14]. The employment of THz-band transmission to achieve SWIPT to millimeter-scale battery-limited THz device, introduced as simultaneous THz information and power transfer (STIPT) [15], is a prospective research direction in 6G and beyond networks. However, to the best of our knowledge, STIPT is not yet explored from the perspective of THz transmission using pulse-based modulation.

Here, Millimeter-scale is used as an adjective for either device, rectenna, or IntRx, but not for the battery. However, millimeter-scale THz devices will also be battery-limited. Hence, the term millimeter-scale battery-limited IntRx. The battery-limited IntRx generally refers to a system with less than required, or no capacity (measured in units of Amp-hour) to hold electrical energy to complete its operation. This system may not be able to accommodate a (large) battery due to its limited size or weight constraints. These battery-limited systems, such as battery-limited receivers, have to harvest energy wirelessly to sustain their operations.

Typically, the physical dimensions of any electrical system are inversely proportional to the operating frequency. Operating in high-frequency bands (e.g. THz band) allows devices to be developed and fabricated at a millimeter-scale. However, powering devices of this scale can be extremely challenging due to their physical limitations to accommodate a large standalone battery, and thus, they rely on a long-range wireless power transfer. Application of such millimeter-scale battery-limited devices can be implantable medical devices, nano-drones, and many more futuristic applications in a 6G era encompassing radio receivers of millimeter-scale.

The joint employment of THz communication and sensing (radar imaging and localization) is a breakthrough in the future 6G networks [16]. Location-aware communication in 6G is indispensable due to the narrow THz beams and the need to track mobile users [1]. Similar to the classification of joint radar-communications (JRC) in low-frequency bands [17], coexistence, cooperation, and co-design JRC approaches are provided in the THz band. The co-design implementation is the most promising where same waveform, such as orthogonal frequency division multiplex (OFDM) one, is employed for both radar and communication [16]. However, single-carrier waveform and its variants are better candidates for a co-designed JRC system due to weakened frequency-selectivity of the THz band channel and simpler front-end implementations of the single-carrier THz systems [3]. Moreover, synergistic target-user localization and mapping techniques, such as [18], can also be implemented in future 6G networks to augment THz information and power transfer, simultaneously.

### SUMMARY

This invention pertains to a novel joint employment of THz transmission from the base station to a battery-limited receiver for active radar imaging, wireless information transfer (WIT), and wireless power transfer (WPT), coined here as a Simultaneous THz Imaging with Information and Power Transfer (STIIPT) system.

Terahertz (THz) band transmission has the potential to revolutionize future-generation wireless networks by jointly meeting communication and non-communication demands of their connected devices. Recent advances in THz semiconductor technologies and antenna design are closing the THz band gap in millimeter-scale devices which are often battery-limited. The localization of these mobile devices in future wireless networks is of paramount significance for beamforming to overcome THz propagation loss. Consequently, prospective signal processing techniques with co-design architectures are emerging either for joint communication and sensing or for simultaneous information and power transfer.

A novel approach is provided toward Simultaneous Terahertz Imaging with Information and Power Transfer (STIIPT) from a base station transceiver to an Integrated Receiver (IntRx). Leveraging the non-linear rectenna model for energy harvesting, a customized On-Off Keying (cOOK) modulation scheme is provided for simultaneous communication through a non-linear THz channel while generating a radar-like image to localize the IntRx acting as a target. The theoretical models are corroborated with simulations using a THz band GaAs Schottky diode to demonstrate STIIPT performances which also emphasize the significance of ranging information to optimize rate-energy transfer tradeoff under the cOOK modulation scheme.

This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIG. 1 is a system design of the STIIPT with RI inside the base station, and EH and ID inside the IntRx;

FIG. 2(A) is an antenna equivalent circuit;

FIG. 2(b) is a single diode antenna-rectifier (rectenna) energy harvester circuit;

FIG. 3 is a STIIPT equivalent low-pass transmission model with a non-linearity;

FIG. 4 is a timing diagram illustrating the ranging under random PRF corresponding to running bit sequence of ‘11010’. The true target range (of same colors) is fixed as achieved with second time-around echoes (n=2);

FIG. 5(A) shows power transfer performance, and is a comparison of harvested DC i_{d} over received amplitude constellation space for theoretical upper bound, ideal and real diode simulations, and approximated closed-form expression;

FIG. 5(B) shows convexity of harvested DC power P_{dc} over P;

FIG. 5(C) shows net harvested DC power E[P_{dc}] output at IntRx located at distance d=4, 6, and 8 m from the base station over the varying probability of On-key P_{A} in cOOK scheme;

FIG. 6(A) shows information transfer performance, as a simulated error-free rate and mutual information (MI) rate over P_{A} in cOOK scheme for SNR=3 and 6 dB;

FIG. 6(B) shows simulated and theoretical BER performance over P_{A} in cOOK scheme for SNR=3 and 6 dB;

FIG. 6(C) shows a bit-interval waveform corresponding to Off and On-key with parameters of the demodulator for the information transfer performance;

FIG. 7(A) shows radar ranging performance, as a simulated and theoretical output SNR from IntRx at distance d within MUR corresponding to P_{A}=0.25, 0.15, and 0.1 in cOOK scheme;

FIG. 7(B) shows ROC curves for the probability of detection over false-alarm for the same three received SNR figures;

FIG. 8(A) shows STIIPT performance tradeoff, as a Rate-Efficiency curves at d=2.5 m over an allowable choice of cOOK modulation symbol length L; and

FIG. 8(B) shows allowable tradeoff limits for information rate and average harvested DC power using cOOK scheme to IntRx at distance d from the base station.

The figures show illustrative embodiment(s) of the present disclosure. Other embodiments can have components of different scale. Like numbers used in the figures may be used to refer to like components. However, the use of a number to refer to a component or step in a given figure has a same structure or function when used in another figure labeled with the same number, except as otherwise noted.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

### II. System Design

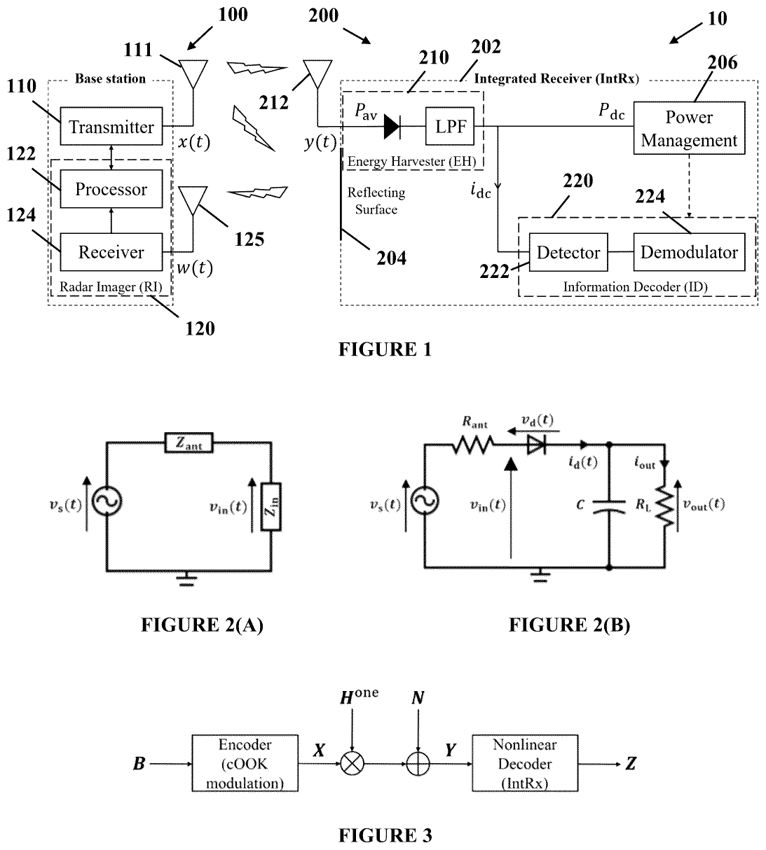

FIG. 1 shows the overall architecture of a point-to-point STIIPT system 10 in accordance with one non-limiting example embodiment of the present disclosure. The STIIPT system 10 includes a single THz transmitter-receiver base station 100, propagation effects, and millimeter-scale battery-limited integrated-receiver (IntRx) 200.

The base station 100 includes a transmitter 110 and Radar Imager (RI) 120. The Radar Imager 120 has a processor 122 and a receiver 124. The transmitter 110 is equipped with a THz source which transmits an amplitude modulated pulsed signal through a transmitter antenna 111 towards the IntRx 200. Since the high radio frequency sinusoids carry electromagnetic wave energy, they can be harvested in the IntRx 200 and the amplitude of the transmitted pulses convey information, simultaneously. The THz signal which is reflected from reflecting surface 204 of the IntRx 200 is then received by the receiver 124 through its receiver antenna 125. The processor 122 inside the radar imager 120 then estimates the delay in the received signal from the receiver 124 by comparing it with the transmitted signal copy available from the transmitter 110. The delay estimated by the processor 122 consequently corresponds to the distance (also called range) of the IntRx 200 from the base station 100, as calculated by the radar imager 120. Subsequently, this distance is communicated back to the transmitter 110 which can be then used for adapting the customized OOK modulation scheme to favor either power or information transfer.

The IntRx 200 has a rectenna-based energy harvester (EH) 210, information decoder (ID) 220, and a power management module 206. The housing 202 of the IntRx 200 has a reflecting surface 204 with a large reflection coefficient. The Information Decoder 220 includes a detector 222 and a demodulator 224. The reflecting surface 204 is provided to act as a reflector for our frequency of operation. The EH sustains the operations of the system (ID in our case 220) on its own and in real-time. However, for the sake of completeness, some systems do include a (small, limited) battery for regulation and management of power to justify continuous system operations even during interruptions. In some embodiments, the IntRx receiver 200 is a millimeter-scale battery-limited radio receiver. 6G and beyond wireless communication networks will be operating in millimeter-wave and THz bands, which will promote the development of millimeter-scale devices.

The IntRx 200 receives the incoming amplitude modulated pulsed signal from the base station 100 through the Integrated Receiver antenna 212. The signal received by the antenna 212 is then absorbed by the EH 210, encompassing a THz diode-based rectifier with a low-pass filter, to harvest energy from the received signal. This harvested power is then regulated and delivered to the ID 220 through a power management unit 206. Typically, the EH 210 sustains the operations of the ID 220 on its own and in real-time through power management unit 206. However, during interruptions, power management unit 206, comprising a chain of passive and low-pass filtering components, supply energy to the ID 220 to seamlessly complete its operation. Additionally, the varying output current received directly from the EH 210 is compared inside the detector 222 with a threshold to establish sensing of either an ‘on’ or ‘off’ pulse. This information from the detector 222 is then fed into the demodulator 224 which ultimately decodes the pulses into binary data ‘1’ or ‘0’. As mentioned before, a part of the incoming signal is reflected by the dedicated reflecting surface 204 attached to the inside of the housing of the IntRx 200. This allows the radar imager 120 to receive and process the reflected THz signal, and then estimate the range of the IntRx 200.

Therefore, the system 10 transfers both power and information simultaneously from the transmitter 110 of the base station 100 to the IntRx 200, and performs radar-like sensing of the IntRx 200 inside the radar imager (RI) 120 located at the base station 100.

The system of the present disclosure provides a novel approach for STIIPT from a base station 100 transceiver to a millimeter-scale battery-limited integrated receiver (IntRx) 200 in the far-field by employing a low-complexity single-carrier signal design scheme. In SWIPT [9], [10], there exists a tradeoff between information transfer and wireless power transfer under transmit power constraints. Far-field is the region around a radiating element, such as an antenna, where the radiated electromagnetic wavefront becomes perpendicular to the direction of wave propagation. This region begins at a distance from the antenna that is several wavelengths away, and it depends on the size of the antenna (D) and operating wavelength (λ), expressed as D²/λ. In our case, the far-field region starts from 2.3 m and beyond. In order to meet the minimum delivered power requirement, one of the most significant parameters to optimize this rate-energy (R-E) tradeoff is the distance of IntRx 200 from the base station 100. The increase in THz path loss with the distance can partially be compensated by adapting the signal waveform to favor energy harvesting over information rate, provided an accurate distance of the target (IntRx 200) from the base station 100 is available. Thus, imaging and localization of the IntRx 200 are of paramount importance not only to direct THz narrow beam on the IntRx 200 for STIPT but also to adapt THz signaling scheme for R-E optimization when IntRx moves relative to the base station.

Leveraging the ultra-wide bandwidth in the THz band, we devise a novel customized On-Off Keying (cOOK) modulation scheme for STIIPT under transmit average power and peak power constraints. The customization in terms of symbol length, corresponding to a probability of On-key transmission, can be performed to maximize either rate or energy while providing continuous range estimation on the IntRx 200. This is explained by providing in the rest of the present disclosure, a theoretical model for each of the imaging, information transfer, and power transfer in the presence of cOOK scheme. The models are validated by simulations as a proof-of-concept to perform all three simultaneously: (a) imaging of the 2D space with continuous ranging, (b) THz communication with Gbps information rate and nanoseconds latency, and (c) efficient wireless power transfer. This disclosure is the first of its kind to jointly combine the design of a signaling scheme for the three most critical and interrelated functionalities of the future 6G and beyond networks. The contributions of this disclosure are summarized as follows.

First, a complete system model is presented, starting with the generation of THz signal at the base station 100, its free-space propagation, its detection by the IntRx 200, and finally its reflection to the base station 100. The presented model represents the input THz signal to ID and EH, as well as to radar imager (RI) 120 inside the base station 100 to achieve STIIPT.

Second, a non-linear analytical model of the IntRx 200 architecture is presented. The IntRx 200 does not need a power-hungry local oscillator and mixer, and it is capable of both energy harvesting and information decoding. Unlike currently adopted truncated Taylor series models in WPT architectures, the presented non-linear diode model provides an upper-bound to the harvested DC corresponding to the non-negative amplitude constellation space of the incoming THz signal.

Third, since the harvested DC power is a convex function of incoming signal power, this reaffirms the usage of OOK modulation scheme as a limiting case for maximizing harvested DC power under available average and peak power constraints. Consequently, it motivates us to devise a novel cOOK modulation-demodulation scheme employed to perform STIIPT.

Fourth, a novel non-linear THz channel is provided comprising a distance-dependent additive Gaussian (molecular absorption) noise channel followed by non-linear rectification in the IntRx 200. Subsequently, using the cOOK modulation scheme, we derive the achievable information rate, bit-error probability, and latency in the presence of the non-linear THz communication channel.

Fifth, we formulate the 2D radar imaging of space followed by a mechanism for continuous range estimation of the detected target (IntRx 200) up to tens of meters from the base station 100. This is achieved in the presence of ultra-high jittered (On) pulse repetition frequency (PRF) corresponding to the transmission of cOOK modulated random data bits at Gbps rate.

Sixth, the theoretical results are supported with simulations involving a THz band GaAs Schottky diode in the IntRx 200, and the performance in terms of power transfer efficiency, information transfer rate, and range estimation is evaluated under cOOK scheme. Finally, the allowable limits are demonstrated within which R-E tradeoff can be optimized by exploiting the range of the detected IntRx 200 from the base station 100. This highlights the employability of THz imaging and localization along with THz information and power transfer to achieve STIIPT in future networks.

The rest of the disclosure is organized as follows: the overall design of the STIIPT system is introduced in Section II, the non-linear rectenna model of EH 210 is derived in Section III, the cOOK modulation scheme for information transfer is presented in Section IV, radar imaging with continuous ranging mechanism is explained in Section V, STIIPT simulation results and discussion are provided in Section VI, and finally, the disclosure is concluded in Section VII.

Throughout this disclosure, the operators ε{·} and E[·] refer to time-averaging and statistical expectation, respectively. Bold uppercase letters denote vectors. Uppercase letters which are not bold stand for random variables except when they are related to circuit notations. The probability density (mass) function of a continuous (discrete) random variable X is denoted by p_X (x). |·| and ∥·∥ refer to the absolute value of a scalar and the 2-norm of a vector, respectively. R{·} denotes the real part of the complex number.

### A. Signal Transmission

This section explains the transmission of the pulsed THz signal from the base station 100 using its dedicated transmitter 110 and highly directional antenna 111 with a narrow pencil-like beamwidth, as in the embodiment of FIG. 1. Highly directional uses a half-power beamwidth (in degrees) and gain (in dB) stated as Gₜ below. Here the transmitter 110 internally embodies the entire transmission chain involving THz frequency oscillator, pulse modulator, and a power amplifier. The transmitter 110 is capable of amplitude modulating a pulsed signal x(t) as,

$$x ( t ) = \{ {\sum }_{i = 0}^{∞} u ( t - i {T}_{c} ) {X}_{i} {e}^{j 2 π ft} \} \qquad ( 1 )$$

$$where$$

$$u ( t ) = \{ \begin{matrix}1 & 0 \leq t \leq {T}_{c} \\ 0 & elsewhere\end{matrix} ,$$

is a unit chip with duration T_{c} and Xᵢ is amplitude of the single carrier with frequency ƒ in the ith chip. The transmission x(t), with low-pass equivalent first-null bandwidth B=1/T_{c} Hz, is subject to transmit average power E[P] and peak power Pₚₖ≤E[P]×PAPR constraints where PAPR is the maximum allowable peak-to-average-power ratio. Here B<<ƒ where B and ƒ are in order of Gigahertz (GHz) and Terahertz (THz), respectively.

Next, we assume x(t) is modulated with an on-off keying scheme, then under given average and peak power constraints, the amplitude Xᵢ has a probability mass function given by

$${f}_{X} ( x ) = \begin{matrix}1 - {P}_{A} , & x = 0 , \\ {P}_{A} , & x = A = \sqrt{2 E [ P ] / {P}_{A}}\end{matrix} \qquad ( 2 )$$

where P_{A}∈(PAPR⁻¹, 1) is the probability of On-key with amplitude A and where P=X²/2 is the power in the ith chip. Since E[X²]=2E[P] can be verified using Equation (2), the average power constraint E[P] is satisfied. In other words, within peak power Pₚₖ constraint, a higher symbol amplitude can be transmitted from the transmitter 110 with lower transmit probability and vice-versa while meeting the average power constraint E[P]. This THz pulse-modulated signal is then radiated from the transmitter 110 towards an IntRx 200 using a narrow beam from a highly directional antenna 111 with gain Gₜ.

### B. Signal Propagation

This section pertains to propagation from the base station 100 to the IntRx 200. The propagation of the THz signal between the base station 100 and the IntRx 200, assuming a line-of-sight (LoS) path with negligible non-LoS (NLoS) paths, is majorly affected by the spreading loss and the molecular absorption loss. The channel response Hₛₚᵣ accounting for spreading loss at a distance d assuming spherical propagation from an isotropic source is given by,

$${H}_{spr} = \frac{1}{\sqrt{4 π} d} . \qquad ( 3 )$$

Molecular absorption loss occurs when a fraction of the propagating wave energy is converted into kinetic energy of the fluctuating molecules. This is defined as the transmittance of the medium at a given frequency ƒ and is obtained using the Beer-Lambert Law. From [19], the channel response H_{abs} accounting for the molecular absorption loss at a distance d is given by,

$${H}_{a b s} = exp ( - \frac{1}{2} k ( f ) d ) \qquad ( 4 )$$

where k(ƒ) is the medium absorption coefficient given as,

$$k ( f ) = {\sum }_{i} \frac{p}{{p}_{0}} \frac{{T}_{S T P}}{T} {Q}_{i} {δ}_{i} ( f ) ,$$

where p is the system pressure in atm, p₀ is the reference pressure (1 atm), T is the system temperature in Kelvin, T_{STP} is the temperature at standard pressure (273.15 K), Qᵢ is the number of molecules per unit of gas i and δᵢ is the absorption cross-section of the gas i. More detail on its derivation using radiative transfer theory can be found in [19] and all parameters can be extracted from the high-resolution transmission molecular absorption database (HITRAN) [20].

In addition to the above attenuation, the THz signal is also subject to noise which includes thermal noise due to receiver multiplier and mixer chains, and absorption noise that is channel-induced due to water vapor. Since the channel-induced noise component is dominant in pulse-based systems, we do not consider transmission-induced molecular noise as the model has not yet been validated by measurements [1]. This dominant noise contribution comes from a very large number of molecules, randomly positioned across the channel. By invoking the Central Limit Theorem, the total noise contribution can be modeled with Gaussian distribution [14]. Thus, we model the additive channel noise n(t) as

$$n ( t ) = {\sum }_{i = 0}^{∞} u ( t - i {T}_{c} ) {n}_{i} ( t ) \qquad ( 5 )$$

$$where$$

$${n}_{i} ( t ) = {N}_{i , R} cos ( ω t ) - {N}_{i , I} sin ( ω t )$$

is the narrowband representation of the noise in chip i which is independent of the noise in the other chips.

$${N}_{i , R} , {N}_{i , I} ∼ ( 0 , {σ}_{n}^{2} )$$

are i.i.d. Gaussian random variables corresponding to a real and imaginary component of the low-pass complex noise representation, respectively. Consequently, the total noise power

$$E [ ℰ \{ {( n ( t ) )}^{2} \} ] = {σ}_{n}^{2}$$

for a given frequency ƒ at a distance d can be expressed as [19],

$${σ}_{n}^{2} = {k}_{B} {\int }_{f - B / 2}^{f + B / 2} {T}_{n o i s e} ( v , d ) dv \qquad ( 6 )$$

where k_{B} is the Boltzmann constant and Tₙₒᵢₛₑ=T_{sys}+Tₘₒₗ+Tₒₜₕₑᵣ is the sum of equivalent noise temperatures in Kelvin that an isotropic antenna detects corresponding to electronic noise, molecular absorption noise, and other noise sources. However, in the absence of multipliers and mixer chains in the receiver, T_{sys} and Tₒₜₕₑᵣ can be assumed negligible. Thus, the dominant molecular absorption noise temperature can be given as [19],

$${T}_{mol} ( f , d ) = {T}_{0} ( 1 - {e}^{- k ( f ) d} )$$

where T₀ is the reference temperature and 1−e^{-k(ƒ)d} is the emissivity measure of the channel.

### C. Signal Detection in IntRx

The transmitted signal through the THz channel is received by the IntRx 200 equipped with an isotropic antenna 212. The overall system response for one-way signal propagation H^{one} accounting for transmitter antenna 111, total channel response, and IntRx antenna 212 can be written as,

$${H}^{o n e} = \sqrt{{G}_{t}} \cdot {H}_{spr} \cdot {H}_{a b s} \cdot λ / \sqrt{4 π} = ( \frac{c \sqrt{{G}_{t}}}{4 π fd} ) {e}^{- \frac{1}{2} k ( f ) d} \qquad ( 7 )$$

where Gₜ is transmit antenna 111 gain, λ is the wavelength, c is the speed of light in free space, and Hₛₚᵣ and H_{abs} are as per Equation (3) and Equation (4), respectively. Due to negligible NLoS paths, our pulsed transmission occupies a relatively narrow bandwidth that is less than the coherence bandwidth. In addition, within this narrow bandwidth, the medium absorption coefficient k(ƒ) is assumed constant. Hence, the system response in Equation (7) is assumed frequency flat-fading around carrier frequency ƒ. Thus, the signal in the presence of noise available at the IntRx becomes,

$$y ( y ) = \{ {\sum }_{i = 0}^{∞} u ( t - i {T}_{c} - \frac{d}{c} ) {H}_{i}^{o n e} {X}_{i} {e}^{j 2 π f ( t \frac{d}{c} )} \} + n ( t ) \qquad ( 8 )$$

where Hᵢ^{one} is the one-way overall system response corresponding to chip i which is assumed constant for the duration of the chip, d/c is one-way signal propagation time, and n(t) is the narrowband noise as in Equation (5) which is distance d dependent only. Consequently, the signal power available to IntRx due to Equation (8) is Pₐᵥ=E[ε{|y(t)|²}].

The IntRx 200 architecture comprises an antenna 212 attached to the THz diode acting as a rectifier inside EH 210. This rectifier-antenna combination, called rectenna, (where the concatenation of the antenna 212 and the EH 210 is called a rectenna) implements the power transfer from the antenna 212 to the rectifier through the matching network (the antenna and rectifier are electrically matched—a lossless connection). FIG. 2(a) illustrates an equivalent circuit of lossless antenna modeled as a voltage source vₛ(t) with antenna impedance Zₐₙₜ=Rₐₙₜ+jXₐₙₜ in series, where Rₐₙₜ and Xₐₙₜ denotes antenna radiation resistance and reactance, respectively. Similarly, the rectifier is modeled with impedance Zᵢₙ=Rᵢₙ+jXᵢₙ. In the impedance-match case (Zₐₙₜ=Zᵢₙ*), the rectifier resistance Rᵢₙ completely absorbs the THz signal power available from the antenna Pₐᵥ, so that Pₐᵥ=E[ε{|vᵢₙ(t)|²}]/Rₐₙₜ. Since Pₐᵥ=E[ε{|y(t)|²}], we have

$${v}_{i n} ( t ) = \frac{{v}_{s} ( t )}{2} = y ( t ) \sqrt{{R}_{a n t}} .$$

### D. Signal Reflection to Base-Station

Due to a large reflection coefficient γ of the target IntRx 200 housing, the signal is reflected from 204 and received via a LoS path at the base station 100 through an antenna 125 with an effective aperture area A_{eff}. The overall system response for the two-way signal propagation H^{two} accounting for the transmitter antenna 111 and receiver antenna 125 at the base station 100, two-way total channel response, and reflection coefficient of target, can be written as,

$$\begin{matrix}{H}^{t w o} = \sqrt{{G}_{t}} \cdot {H}_{spr}^{2} \cdot {H}_{a b s}^{2} \cdot γ \cdot \sqrt{{A}_{eff}} \\ = ( \frac{c γ \sqrt{{G}_{t} {G}_{r}}}{4 π \sqrt{4 π} f {d}^{2}} ) {e}^{- k ( f ) d}\end{matrix} \qquad ( 9 )$$

where Gᵣ=4πA_{eff}/λ² is the receiver antenna 125 gain at the base station 100. The reflection coefficient γ depends on the dielectric material, shape, and roughness of the receiver body surface. Since we consider reflected surface correlation length much greater than THz operating wavelength, Kirchhoff scattering theory to capture reflection loss under specular reflection is applicable. Considering the Transverse Electric (TE) part of the electromagnetic wave, the reflection coefficient γ can be obtained as,

γ=Γ_{TE}·μ

where Γ_{TE} is the Fresnel reflection coefficient for TE polarized waves on the smooth surface which is approximated as

$${Γ}_{T E} \approx - exp ( \frac{- 2 cos ( {θ}_{i} )}{\sqrt{{υ}^{2} - 1}} )$$

where θᵢ is the angle of the incident wave and v refers to the refractive index of the surface material. μ is the Rayleigh roughness factor given as,

$$μ = exp ( - \frac{8 {π}^{2} {f}^{2} {σ}^{2} {cos}^{2} ( {θ}_{i} )}{{c}^{2}} )$$

where σ is the rough surface height standard deviation, which is commonly considered as Gaussian distributed.

Again in our design, the overall system response in Equation (9) including channel and antenna response is assumed frequency flat-fading due to narrowband transmission. Thus, the signal returned to the base station in the presence of noise becomes,

$$w ( t ) = ℜ \{ {\sum }_{i = 0}^{∞} u ( t - i {T}_{c} - \frac{2 d}{c} ) {H}_{i}^{t w o} {X}_{i} {e}^{j 2 π f ( t - \frac{2 d}{c} )} \} + \tilde{n} ( t ) \qquad ( 10 )$$

where

$${H}_{i}^{t w o}$$

is the two-way overall system response corresponding to chip i and which is assumed constant for the duration of the chip, 2d/c is the signal echo time, and ñ(t) is the narrowband noise as in Equation (5) which is twice the distance \tilde{d}=2d dependent only. We do not consider the Doppler effects on the returned signal Equation (10) as the target receiver is assumed stationary when the base station performs radar ranging.

### III. Energy Harvester Model

This section explains energy harvesting through signal rectification in a non-linear device followed by low-pass filtering in the IntRx 200. The novel model upper bounds the harvested Direct Current (DC) in the Energy Harvester EH 210 as a function of incoming signal amplitude. By doing so, we reveal the convexity of harvested DC power as a function of incoming signal amplitude. This justifies the significance of low-complexity on-off keying (OOK) modulation scheme to maximize the average harvested DC power E[P_{dc}] power under fixed separation distance between IntRx and base-station while meeting available average power E[P] and peak power Pₚₖ constraints. In addition, a novel closed-form expression for the approximation of the presented non-linear EH model is also elaborated.

### A. Non-Linear Harvester Model

Consider a simple rectifier circuit as shown in FIG. 2(b) composed of a single THz diode in series with a low-pass RC network containing load resistance R_{L}. Although this rectifier circuit is based on a single diode, it holds valid for more general rectifiers with many diodes [21]. As shown in FIG. 2(b), the voltage drop across the diode v_{d}(t)=vᵢₙ(t)−vₒᵤₜ(t), where vᵢₙ(t) is the input voltage to diode and vₒᵤₜ(t) is the output voltage across the resistor R_{L}.

Given a diode characteristic function,

$${i}_{d} ( t ) = {i}_{s} ( {e}^{{v}_{d} ( t ) / η {v}_{t}} - 1 ) = {i}_{s} ( {e}^{{v}_{i n} ( t ) - {v}_{o u t} ( t ) / η {v}_{t}} - 1 ) \qquad ( 11 )$$

where iₛ is reverse bias saturation current, vₜ is thermal voltage, and η is the diode ideality factor. Note that i_{d}(t)>−iₛ and so ε{i_{d}(t)}>−iₛ. In Equation (11), expressing vᵢₙ(t) in terms of a sinusoidal source voltage vₛ(t) and assuming a steady-state response with an ideal low-pass filter, vₒᵤₜ(t)≈ε{vₒᵤₜ(t)}=ε{i_{d}(t)}R_{L}, thus

$${i}_{d} ( t ) = {i}_{s} ( {e}^{{v}_{s} ( t ) - {i}_{d} ( t ) {R}_{a n t} - ε \{ {i}_{d} ( t ) \} {R}_{L} / η {v}_{t}} - 1 ) \\ or ( \frac{{i}_{d} ( t )}{{i}_{s}} + 1 ) {e}^{ε \{ {i}_{d} ( t ) \} {R}_{L} + {i}_{d} ( t ) {R}_{a n t} / η {v}_{t}} = {e}^{{v}_{s} ( t ) / η {v}_{t}} . \qquad ( 12 )$$

Now taking the time-average on both sides of Equation (12) and invoking Jensen's inequality on l.h.s.,

$$( \frac{{i}_{d}}{{i}_{s}} + 1 ) {e}^{{i}_{d} ( {R}_{L} + {R}_{a n t} ) {/}_{η {v}_{t}}} \leq ε \{ {e}^{{v}_{s} ( t ) {/}_{η {v}_{t}}} \}$$

where i_{d}=ε{i_{d}(t)} is the time-averaged i_{d}(t) which can possess statistical randomness depending upon the statistical randomness of the transmitted signal. Without loss of generality, we consider single-chip transmission in Equation (1) with X=X₀={0, A} and frequency-flat channel response

$$H = \vert {H}_{0}^{o n e} \vert .$$

Furthermore, we assume that the contribution of noise n(t) towards energy harvesting only is very small and thus it can be safely ignored. So,

$$( \frac{{i}_{d}}{{i}_{s}} + 1 ) {e}^{{i}_{d} ( {R}_{L} + {R}_{a n t} ) {/}_{η {v}_{t}}} \leq ε \{ {e}^{2 y ( t ) \sqrt{{R}_{a n t}} {/}_{η {v}_{t}}} \} = ε \{ {e}^{2 HX sin ( 2 π ft ) \sqrt{{R}_{a n t}} {/}_{η {v}_{t}}} \} \qquad ( C )$$

which can be rewritten as

$$g ( {i}_{d} ) \leq \frac{1}{2 π} {\int }_{- π}^{π} {e}^{ρ sin ( τ )} d τ = \frac{1}{2 π} {\int }_{- π}^{π} {e}^{ρ sin ( τ ) - j v τ} d τ {\vert}_{v = 0} g ( {i}_{d} ) \leq \frac{1}{2 π} {\int }_{- π}^{π} {e}^{j ( - j ρ sin ( τ ) - v τ )} d τ {\vert}_{v = 0} \qquad ( 13 )$$

where g(i_{d}) is a convex function of i_{d} and ρ=2HX \sqrt{Rₐₙₜ}/(ηvₜ).

Now, expressing r.h.s. of Equation (13) as a modified Bessel function of the first kind, order zero I₀(·) and denoting h(·) as an inverse function of g(·) which is monotonically increasing and concave, Equation (13) can be rewritten as,

$${i}_{d} \leq h \{ {I}_{0} ( ρ ) \} . \qquad ( 14 )$$

Here the upper bound on i_{d} can be solved using a numerical approach to find the inverse function h(·), which can also be expressed using Lambert W function. Finally, squaring Equation (14), the upper-bounded DC power of P_{dc} delivered to load R_{L} will be

$${P}_{d c} = {i}_{d}^{2} {R}_{L} \leq {[ h \{ {I}_{0} ( ρ ) \} ]}^{2} {R}_{L} . \qquad ( 15 )$$

Equation (15) provides a novel tractable model depicting the relationship of received signal amplitude to harvested DC power without truncation of higher-order terms. Furthermore, with power |H|²P received per chip for rectification in the case of the perfect antenna-rectifier impedance matching, the source voltage signal vₛ(t)=2\sqrt{Rₐₙₜ}y(t) has a peak amplitude Vₛ=2\sqrt{Rₐₙₜ}|H|X=\sqrt{8Rₐₙₜ|H|²P}. Since the relationship between received and transmitted signal amplitude can be provided by the distance-dependent channel response H, Equation (15) leads to traditional analysis of harvested DC power P_{dc} for a given transmit power P.

Finally, for a particular channel response H we can approximate i_{d} in Equation (14) using a closed-form expression. Particularly, under the given input power constraints, the following non-linear function ƒ(X) can be devised to represent harvested DC chip output Z,

$$Z = {i}_{d} ≅ f ( X ) = - α + \sqrt[q]{{α}^{q} + {( β X )}^{q}} \qquad ( 16 )$$

where α and β are small constants, and q≥2 is an even positive integer obtained by fitting ƒ(X) to the experimental harvested DC curves corresponding to the fixed separation distance between the IntRx 200 and the base station 200 as discussed ahead in section VI-A.

### B. Convexity of Harvested DC Power

The currently adopted non-linear diode model in WPT architectures, which is truncated to fourth-order term, accounts for the dependence of RF-to-DC power conversion efficiency η=P_{dc}/P of the rectifier circuit on the input signal power [8]. Consistently, for fixed H, our upper-bounded non-linear diode model presented above theorizes the significance of high symbol amplitude variability of input signal for increasing the net harvesting power efficiency,

$${η}_{n e t} {=}^{Δ} \frac{E [ {P}_{d c} ]}{E [ P ]} \qquad ( 17 )$$

calculated with average output power over average transmitted power. Since P_{dc}=ηP is the convex function of P [9], we can simply write

$$E [ {P}_{d c} ( P ) ] \geq {P}_{d c} ( E [ P ] )$$

due to Jensen's inequality. This implies that the net harvesting power efficiency ηₙₑₜ in Equation (17) due to varying input power is greater or equal to the efficiency of a carrier with fixed input power, i.e.,

$${η}_{n e t} = \frac{E [ {P}_{d c} ( P ) ]}{E [ P ]} \geq \frac{{P}_{d c} ( E [ P ] )}{E [ P ]} . \qquad ( 18 )$$

The result in Equation (18) highlights that a modulated signal with a higher peak-to-average power ratio (or lower probability of On-key, P_{A}) will benefit more from the convexity of harvested DC power P_{dc}. So, under average power E[P] and peak power Pₚₖ constraints, ηₙₑₜ can be maximized using a flash signaling with peak power Pₚₖ.

### IV. Modulation and Information Transfer

In this section, we first provide a generalization to On-Off Keying (OOK) modulation scheme called customized On-Off Keying (cOOK) which is used for transmission under given average and peak power constraints. A complete THz channel model followed by an integrated receiver (IntRx) is explained and employed to calculate the theoretical capacity and achievable information rate with cOOK in the presence of Gaussian noise. The demodulation of the scheme in the ID with calculations of bit-error probability and latency are provided at the end.

A. Customized On-Off Keying (cOOK) Modulation

A cOOK scheme is provided to modulate the transmitted signal waveform at the transmitter 110 for sending it from the base station 100 to the IntRx 200. The cOOK is a generalized case of a Return-to-Zero On-Off Keying (RZ-OOK) scheme with two L-chip line code symbols each corresponding to either binary digit. Specifically, it encodes digit ‘0’ with Off-key (absence of pulse) in all L chips of the symbol, and digit ‘1’ with On-key (presence of pulse) in only first chip and Off-key in rest of the chips of the symbol. In cOOK, the number of chips L≥1 in the symbol can be customized to meet transmitter average and peak power constraints. With L=1 chip per symbol, the cOOK scheme reduces to Non Return-to-Zero OOK (NRZ-OOK) scheme. Therefore, with cOOK and ignoring channel coding overhead, the symbol length is equivalent to bit-interval T_{b}=LT_{c} where T_{c} is the fixed chip-width corresponding to time τ required to attain steady-state in IntRx as explained later.

As stated previously, the transmitter 110 internally embodies the entire transmission chain which involves a THz frequency oscillator, a pulse modulator implementing the cOOK modulation scheme, and a power amplifier.

### B. Non-Linear Channel Model

Consider a discrete-time memoryless communication system as shown in FIG. 3 where every digit from a binary source B is represented with an L-chip cOOK to yield a signal line code amplitudes X=(X₁, X₂, . . . , X_{L}). The cOOK modulator is equivalent to an encoder shown in FIG. 3 producing either of the two orthogonal codes. When the source digit is ‘0’, X=(0, 0, . . . , 0), and when it is ‘1’, X=(A, 0, . . . , 0) where A∈ [symbol] . Under amplitude constraints as presented in the PDF of Xᵢ Equation (2), the customizable symbol length L is equivalent to 1/(2P_{A}) where P_{A} is the likelihood of Xᵢ=A assuming equiprobable digits in the binary source, i.e., Pr(1)=Pr(0)=0.5.

Next, X is modulating a single-carrier sinusoid for transmission through the THz channel having a one-way response

$${H}^{o n e} = {\{ {H}_{i}^{o n e} \}}_{1}^{L}$$

accounting for all the losses in Equation (7). The transmission is also subject to narrowband noise represented as

$$N = {\{ {N}_{i} \}}_{1}^{L}$$

where the complex Gaussian low-pass noise equivalent Nᵢ=N_{i,R}+jN_{i,I} is assumed constant and independent for each chip i. Both

$${N}_{i , R} ∼ ( 0 , {σ}_{n}^{2} ) and {N}_{i , 1} ∼ ( 0 , {σ}_{n}^{2} )$$

are i.i.d. Gaussian random variables with distance-dependent only noise power σₙ² from Equation (6). The equivalent low-pass complex noisy input amplitudes to the IntRx then become

$$Y = {\{ {Y}_{i} \}}_{1}^{L}$$

where

$${Y}_{i} = {H}_{i} {X}_{i} + {N}_{i , R} + j {N}_{i , I} ,$$

which is rectified into a harvested DC output

$$Z = {\{ {Z}_{i} \}}_{1}^{L}$$

as shown in Equation (16) using a closed-form approximation. Thus, assuming a unity channel response Hᵢ=1, harvested DC output Zᵢ is given by,

$${Z}_{i} \approx - α + \sqrt[q]{{α}^{q} + {( β \vert {Y}_{i} \vert )}^{q}} . \qquad ( 19 )$$

Since a in Equation (19) is a small constant, the output can be further approximated when β|Yᵢ|>>α as,

$${Z}_{i} \approx - α + β \vert {Y}_{i} \vert \approx β \vert {Y}_{i} \vert$$

which is merely a linear function of the magnitude of the complex input |Yᵢ| received at the IntRx. Thus, for capacity calculations using ith chip output, we resort to the following working model of the THz channel followed by IntRx,

$${Z}_{i} = \vert {Y}_{i} \vert = \sqrt{{( {X}_{i} + {N}_{i , R} )}^{2} + {N}_{i , I}^{2}} . \qquad ( 20 )$$

### C. Achievable Information Rate

When X is an invertible function of B, the observation of Z provides I(X; Z) bits of information per symbol where I(X; Z) is the mutual information between X and Z [22]. Therefore, the capacity of the THz channel followed by an IntRx is the maximum amount of bits per channel use that can be transmitted reliably with cOOK modulation scheme under given power constraints and is given by,

$$𝒞 = {max}_{{f}_{X} ( x )} I ( X ; Z ) = {max}_{{f}_{X} ( x )} \{ H ( Z ) - H ( Z \vert X ) \} \qquad ( 21 )$$

where H(·) is the entropy function. In cOOK, Z₁ provides sufficient statistics for the input X with X₁∈{0, A} which is equiprobable. So, dropping chip index subscript in Equation (21), its maximum achievable rate [symbol] can be written as,

$$ℛ = H ( Z ) - H ( Z \vert X ) = H ( Z ) - {\sum }_{j = 1}^{2} {f}_{X} ( {x}_{j} ) H ( Z \vert X = {x}_{j} ) .$$

Since ƒ_{X}(A)=ƒ_{X}(0)=½ where A=\sqrt{(2E[P])/P_{A}}. Thus, using Equation (20),

$$ℛ = \frac{1}{2} {\int }_{0}^{∞} {f}_{Z \vert X} ( z \vert X = A ) {log}_{2} ( \frac{{f}_{Z \vert X} ( z \vert X = A )}{{f}_{Z} ( z )} ) + {f}_{Z \vert X} ( z \vert X = 0 ) {log}_{2} ( \frac{{f}_{Z \vert X} ( z \vert X = 0 )}{{f}_{Z} ( z )} ) dz \qquad ( 22 )$$

$$where$$

$${f}_{Z \vert X} ( z \vert X = 0 ) = \frac{z}{{σ}_{n}^{2}} exp ( - \frac{{z}^{2}}{2 {σ}_{n}^{2}} ) , z \geq 0$$

is Rayleigh distributed, denoted ƒ_{Ray}(z) and,

$${f}_{Z \vert X} ( z \vert X = A ) = \frac{z}{{σ}_{n}^{2}} exp ( - \frac{{z}^{2} + {A}^{2}}{2 {σ}_{n}^{2}} ) {I}_{0} ( \frac{A z}{{σ}_{n}^{2}} ) , z \geq 0$$

is Rice distributed, denoted ƒ_{Ric}(z) and I₀(·) is the modified Bessel function of the first kind and order zero. Lastly, from Equation (22), the achievable rate in terms of bits per second for L=1/(2P_{A}) length symbol can be written as,

$$ℛ = \frac{{P}_{A}}{{T}_{c}} {\int }_{0}^{∞} {f}_{R i c} ( z ) {log}_{2} ( \frac{{f}_{R i c} ( z )}{{f}_{Z} ( z )} ) + {f}_{R a y} \qquad ( 23 )$$

$${\text{?}}_{2} ( \frac{{f}_{R a y} ( z )}{{f}_{Z} ( z )} ) d z$$

$$\text{?} \text{indicates text missing or illegible when filed}$$

where T_{c} is chip interval and ƒ_{Z}(z)=(ƒ_{Ric}(z)+ƒ_{Ray}(z))/2.

### D. Demodulation in IntRx

The demodulation of the harvested DC Z in the IntRx 200 is performed by the ID 220 (demodulation is used to explain the working of the ID 220) using noncoherent detection by maximum likelihood decision rule given as,

$${max}_{1 \leq s \leq S} {f}_{Z \vert {X}_{s}} ( Z \vert {X}_{s} )$$

where Xₛ=(X_{s,1}, X_{s,2}, . . . , X_{s,L}) denotes transmitted signal line code with 1≤s≤S where S=2 in the case of cOOK. Again, since Z₁ provides sufficient statistics for Xₛ through X_{s,1} only, the detector 222 needs to only compare ƒ_{Z}_{₁}_{|X}_{₁}(Z₁|X_{1,1}=0) with ƒ_{Z}_{₁}_{|X}_{₂}(Z₁|X_{2,1}=A) which are Rayleigh and Rice distributions, respectively. This is done by testing Z₁ against a threshold t for the presence or absence of On-key, where threshold t can be obtained by solving,

$$\frac{𝓉}{{σ}_{n}^{2}} {e}^{- \frac{𝓉}{2 {σ}_{n}^{2}}} = \frac{𝓉}{{σ}_{n}^{2}} {e}^{- \frac{{𝓉}^{2} + {A}^{2}}{2 {σ}_{n}^{2}}} {I}_{0} ( \frac{A 𝓉}{{σ}_{n}^{2}} )$$

which results in

$$𝓉 = \frac{{σ}_{n}^{2}}{A} {I}_{0}^{- 1} ( {e}^{\frac{{A}^{2}}{2 {σ}_{n}^{2}}} ) . \qquad ( 24 )$$

Therefore, the probability of bit error can be written as,

$$BER = ( P [ {Z}_{1} > 𝓉 \vert 0 ] + P [ {Z}_{1} < t \vert A ] ) / 2$$

where P[Z₁>t|0] and P[Z₁<t|A] are probabilities of false and missed detection, respectively. Thus,

$$BER = \frac{1}{2} [ 1 + {e}^{- \frac{{𝓉}^{2}}{2 {σ}_{n}^{2}}} - {Q}_{m} ( \frac{A}{{σ}_{n}} , \frac{𝓉}{{σ}_{n}} ) ] \qquad ( 25 )$$

where Qₘ(·) is the Marcum Q-function.

Lastly, assuming correct demodulation of bits by the demodulator 224, the bit latency [symbol] corresponding to the symbol length L=½P_{A} is,

$$ℒ = {T}_{b} - {T}_{c} + {t}_{r} = ( L - 1 ) {T}_{c} + {t}_{r} , \qquad ( 26 )$$

where tᵣ≈τ ln 9 is rise time, and τ=21 ps is the steady-state time-constant of the designed low-pass RC network.

### V. Radar Imaging

In this section, we explain the generation of a 2D image in a noncoherent manner in the radar imager (RI) 120 inside the base station 100. The approach employed for radar-like ranging of the IntRx, which is now a target, is then explained in detail with cOOK modulated transmission. This continuous estimation of the distance of IntRx from the base station is of significance as it allows the transmitter to adapt cOOK modulation to favor either power transfer or information transfer simultaneously. We assume here that the precise timestamping of both the transmitted pulse and its echo is available to the RI processor 122 in the absence of any receiver eclipsing for the range estimation. The radar equation along with the base station receiver output signal-to-noise ratio (SNR) under non-fluctuating target (IntRx) conditions are presented at the end.

### A. 2D Radar Imaging

A single high-gain lens-horn transmitter antenna 111 is employed at the base station 100 to radiate a pencil-like THz beam. The receiver 124 at the base station is also equipped with a colocated high-gain lens-horn antenna 125 at a known separation distance from the transmitter antenna 111. Considering mechanical steering, the THz beam first performs a raster scan of the 2D grid space both in azimuth and elevation. A simple linear detector inside the receiver 124 is tuned to THz carrier frequency which detects the echoes to create a 2D pixel image from the returned intensities. The cm-level spatial resolution corresponding to each pixel is governed by the narrow circular transmit beam width. At the receiver 124, the pixel with intensities above a threshold is attributed to the presence of the target (IntRx). The THz beam is then aligned in the direction corresponding to that pixel for range estimation of the target (IntRx) along with simultaneous power and information transfer. The spatial location of the target (IntRx) is updated by mechanical beam scanning to refresh the 2D image after a fixed time. Similarly, multiple spatially dispersed targets (IntRx) appearing in the image can also be handled for STIIPT with time-sharing of the steerable beam among them. However, we next consider the single target (IntRx) and focus on its simultaneous radar-like ranging once it is localized in the 2D space.

B. cOOK-Based Ranging

The cOOK modulated THz signal has an ultra-short On-key (pulse) of width T_{c} which results in a high maximum pulse repetition frequency, PRF=(LT_{c})⁻¹ where L is the customizable symbol length (chips). From a radar standpoint, high PRF is preferred in pulsed radar (commonly known as pulse-Doppler radar) to detect large Doppler shift (high-velocity target), but due to the short listening time between two consecutive pulses, it reduces the maximum unambiguous range (MUR) which is given by c·PRF⁻¹/2 where c is the transmission speed in the medium. Consequently, simple processing of echoes received after a time delay exceeding one pulse repetition interval (PRF⁻¹) gives an ambiguous range.

Practically, the easiest way to extend the MUR would be to tag successive transmitted pulses, e.g., with a change in (modulating) their frequency in some cyclical pattern. Then, by looking for the corresponding frequency in the target echoes, one could then tell which transmitted pulse each echo belongs to and thereby resolve the range ambiguities. However, this requires multi-carrier transmission and is achieved at the cost of inefficient bandwidth utilization. In the absence of any pulse tagging (or multiple carriers), MUR can also be extended by switching to low PRF for some time or by using a deterministic PRF pattern, e.g., staggered PRF with unambiguous return calculations using the Chinese remainder theorem.

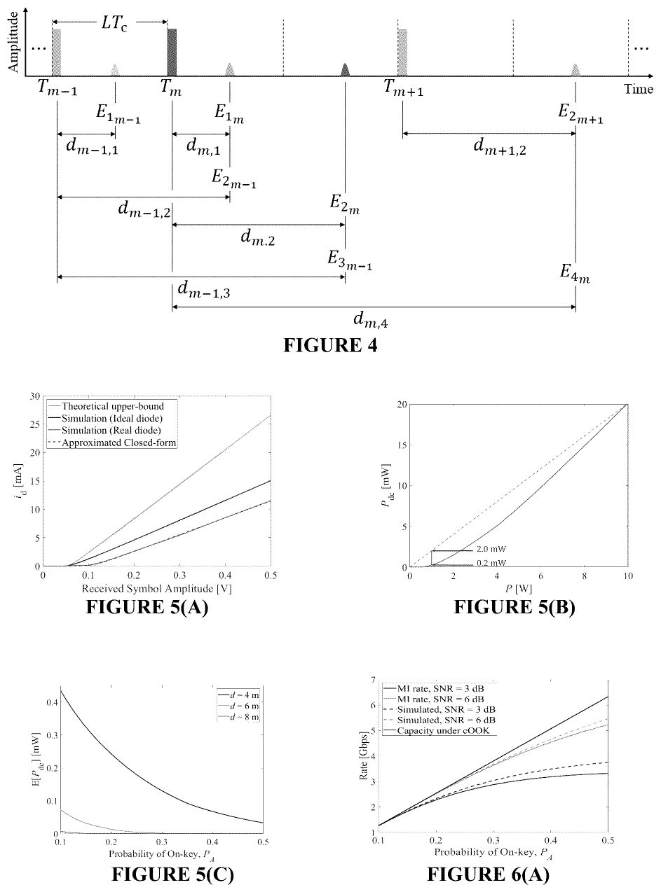

In our case, the cOOK modulated transmission translates to a jittered PRF corresponding to a random bit data sequence. Similar to [23], we attempt to resolve the range ambiguity by exploiting the random positioning of pulse in time due to random transmission of 1's. First, we define an nₘth time-around, nₘ∈{1, . . . , N} as an index of a listening window between time delay (nₘ−1)·LT_{c} and nₘ·LT_{c} since the transmission of the mth pulse where symbol duration LT_{c} is the minimum pulse repetition interval (PRI). An echo, if present, in the nₘth time-around window following the mth pulse is called nₘth time-around echo. That is, for a specific pulse, any echo received within the first PRI of its transmission is first time-around echo, if received after a delay exceeding one PRI but less than two PRIs of its transmission is second time-around echo, and so on. Then as highlighted in FIG. 4, the calculated range corresponding to transmitted pulse m and time-around echo nₘ would be,

$${d}_{m , n} = \frac{c \cdot ( {E}_{{n}_{m}} - {T}_{m} )}{2}$$

where Tₘ and Eₙ_{ₘ} are the base station timestamping of the mth transmitted pulse and the nₘth time-around echo, respectively. Note that E₁_{ₘ} and E₂_{ₘ₋₁} are same in FIG. 4 and represent first and second time-around echo timestamps for the m and m−1 transmitted pulse, respectively. Next, corresponding to the transmission of M jittered pulses, consider a strict M length only difference vector ΔDₙ for n∈ [symbol] where [symbol] ⊆{1, . . . , N} given as,

$$Δ {D}_{n} = {( {d}_{2 , n} - {d}_{1 , n} , … , {d}_{m + 1 , n} - {d}_{m , n} , … , {d}_{M , n} - {d}_{M - 1 , n} )}^{T} . \qquad ( 27 )$$

The ranges due to time-around echoes corresponding to a correct position of the target (IntRx) are unaffected by the jitter in the PRF. Therefore, the correct time-around echo \hat{n} out of N time-arounds can be obtained by minimization of the total-variation in Equation (27) given as,

$$arg {min}_{n ∈ 𝒟} {‖ Δ {D}_{n} ‖}_{1}$$

which results in the correct target range d_{m,\hat{n}}, ∀1<m<M. Thus, range estimation is performed by listening N time-around windows ahead of every pulse. Moreover, the number of pulses M can be selected large enough to avoid with high probability, a detrimental case of periodic 1's in the whole sequence. Following the presented approach, the maximum unambiguous range (MUR) with L=1/(2P_{A}) length symbol can thus be expressed as,

$$MUR = \frac{cN {PRF}^{- 1}}{2} = \frac{{cNLT}_{c}}{2} = \frac{{cNT}_{c}}{4 {P}_{A}} . \qquad ( 28 )$$

### C. Radar Equation and Detection Metric

We now formulate the radar equation to estimate the power at the input to the base station receiver 124, Pᵣ. Using the overall two-way system response from Equation (9), we can directly write,

$${P}_{r} = {\vert {H}^{t w o} \vert}^{2} \cdot {P}_{p k} = \frac{{P}_{pk} {G}_{t} {G}_{r} {λ}^{2} {γ}^{2}}{{( 4 π )}^{3} {d}^{4} L ( d )} \qquad ( 29 )$$

where Pₚₖ is the transmitted pulse power during the On-key satisfying average power constraint E[P]=P_{A}·Pₚₖ as in Equation (2), L(d)=e^{2k(ƒ)d} is the narrowband propagation loss due to molecular absorption, and λ=c/ƒ is the wavelength. Since the two-way system noise power can be approximated as E[ε{(ñ(t))²}]=k_{B}BTₘₒₗ(\tilde{d}), the noise power at the receiver Nᵣ can be written as

$${N}_{r} = {k}_{B} B {T}_{mol} ( \tilde{d} ) F = {k}_{B} B {T}_{s} ( d )$$

where F is the receiver noise figure and Tₛ(d) is the equivalent overall system temperature. Thus, using Equation (29), the received signal-to-noise ratio (SNR) becomes,

$$SNR = \frac{{P}_{r}}{{N}_{r}} = \frac{{P}_{pk} {T}_{c} {G}_{t} {G}_{r} {λ}^{2} {γ}^{2}}{{( 4 π )}^{3} {k}_{B} {T}_{s} ( d ) {d}^{4} L ( d )} . \qquad ( 30 )$$

For a given receiver's sensitivity at the base station, Equation (30) can be used to obtain the theoretical maximum detectable range. Furthermore, for a desired probability of false alarm P_{FA} of the non-fluctuating target (IntRx) and under the given SNR of a single pulse, Alberhseim's equations can be used to obtain the probability of correct detection P_{D}. However, the approach presented in the previous subsection for correct ranging requires an echo to be detected for all M transmitted pulses. Therefore, this reduces the probability of correct detection to P_{D}^{M} which can be a tolerable compromise made to perform ranging with high PRF in STIIPT scenario.

### VI. Results and Discussion

In this section, we evaluate the performance of the THz wireless power transfer, information transfer, and radar imaging by simulating EH, ID, and RI, respectively. The simulations are performed jointly in Matlab and NI Multisim, and the STIIPT performance using cOOK modulation scheme is contrasted with theoretical results presented in the previous sections. We consider cOOK scheme having customizable L=1/(2P_{A}) chips but with fixed chip (On-pulse) duration T_{c}=158 ps transmitted with 340 GHz carrier frequency. The corresponding signal bandwidth thus occupies a THz band with relatively less atmospheric attenuation (around 10 dB/km) beyond natural Friis free space path loss [2]. The cOOK transmission is always subject to average transmit power E[P]=1 W and PAPR≤10 constraints. The signal is propagated through a distance-varying additive Gaussian noise channel due to molecular absorption noise (at 0.1% H₂O) obtained from HITRAN database [20]. The base station transmitter 110 and receiver 124 are each equipped with a 40 dB high-gain lens-horn antenna transmit/receive the signal to/from an IntRx located in the far-field.

### A. Power Transfer Performance

We simulated the complete circuit of EH presented in FIG. 2(b) involving a THz rectifying diode which is implemented using MACOM Madz-011001 (GaAs flip chip Schottky barrier diode) having iₛ=3.97 fA, η=1.12, and vₜ=25.86 mV. Simulations are performed both using an ideal diode (series resistance, Rₛ=0Ω, breakdown voltage, V_{B}=∞) and real diode (Rₛ=3.4Ω, V_{B}=7 V) cut-off frequency parameters in Matlab and NI Multisim, respectively. We first evaluated the optimal load R_{L} in a low-pass R_{L}C network with C=0.3 pF that maximizes the RF-to-DC power conversion efficiency η to account for the impedance mismatch between antenna and rectifier. Additionally, to improve the available power at the IntRx 200, it is attached to a 32 dB gain antenna which results in an average power available Pₐᵥ=11 mW to IntRx at 2.5 m from the base station 100 under transmit average power E[P] constraint and one-way channel response. Consistent between ideal and real diode results, the available RF-to-DC power conversion efficiency η=P_{dc}/Pₐᵥ at the IntRx is estimated to be maximum for R_{L}=180Ω.

We now present the theoretical upper-bound for harvested DC i_{d} as derived in Equation (14) over a non-negative constellation space of on-off keying scheme corresponding to a range of On-pulse symbol amplitudes HX received by IntRx 200 at 2.5 m distance from the base station 100. Consequently, the dependence on X of function h of modified Bessel function of the first kind order zero, particularly h{I₀(ρ)} where ρ=2\sqrt{Rₐₙₜ}HX/(ηvₜ) is presented by numerically solving the function h using the interior point method. As demonstrated in FIG. 5(a), the relationship is linear for large values of received symbol amplitude. Furthermore, both the ideal and real diodes simulated harvested DC i_{d} is shown over the same constellation space along with the theoretical upper-bound. FIG. 5(a) depicts a clear visualization of the harvested DC relationship to received symbol amplitude which can be used to design and evaluate the harvesting performance of an amplitude-based modulation scheme from the non-negative constellation space. In addition, approximate closed-form expression for harvested DC i_{d} as provided in Equation (16) is also plotted in FIG. 5(a). Therefore, using Equation (16), a highly tractable expression with α=0.0034, β=0.03, and q=8 fitted on a simulated (real diode) response, thus provides a computationally less expensive closed-form DC output to conveniently assess the impact of the choice of On-key amplitude constellation points over energy harvesting.

Next, we simulate the convexity of the harvested DC power P_{dc} as a function of transmitted signal power P using real cut-off frequency parameters of MACOM Madz-011001 THz diode-based rectenna at 2.5 m from the base station. As discussed in section III-B, FIG. 5(b) depicts such convexity which can be exploited using a cOOK modulation at the transmitter side. Therefore, under the given E[P]=1 W and Pₚₖ≤10 W constraint, the cOOK modulation scheme with a probability of On-key P_{A}=0.1 in Equation (2) maximizes the average harvested power E[P_{dc}]. As can be seen in FIG. 5(b), in contrast to the fixed transmitted power of E[P] which results in net RF-to-DC conversion efficiency ηₙₑₜ=0.02%, cOOK modulation with E[P] average power results in a ten-fold increase in ηₙₑₜ=0.20%. Lastly, as the LOS distance d between IntRx and base station increases, the received power available at the IntRx decreases with squared distance as per one-way channel response, however, the convexity in harvested DC power can still be exploited by infrequently transmitting On-pulses with high amplitude. FIG. 5(c) shows the average harvested power E[P_{dc}] over possible P_{A} for d=4,6, and 8 m. Therefore, as can be seen in FIG. 5(c), the decrease in received power for harvesting due to distance can be partially compensated by customizing the OOK scheme, provided the separation distance of IntRx from the base station is known to the modulator.

### B. Information Transfer Performance

Under the same cOOK modulation scheme and power constraints, the performance of information transfer is assessed in terms of rate, bit-error-rate (BER), and latency. This is simulated by first generating a pseudo-random bit sequence of cOOK modulated THz signals in Matlab affected by one-way channel response and distance-dependent additive Gaussian noise power. The noisy signals are then passed to NI Multisim for the EH circuit simulation using the real diode parameters to obtain the harvested voltage i_{d}R_{L} across the load. The harvested voltage data corresponding to the transmitted signal line code is then sent back to ID implemented in Matlab. In the detector 222, the presence or absence of On-pulse is detected in the first chip of the signal line code against a threshold t obtained using (Rayleigh and Rician) distributions of the harvested voltage in Equation (24), which is then demodulated as output “1” or “0”, respectively by the demodulator 224 inside the ID 220.

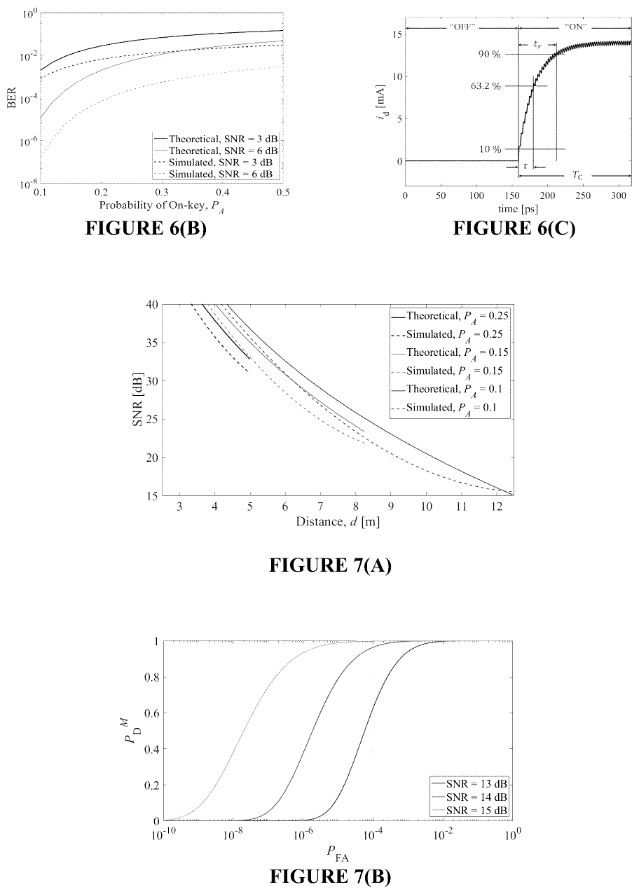

The simulated bit rate corresponding to correct detection is compared with the mutual information rate evaluated using Equation (22). For two different transmitted signal-to-noise ratios (SNRs), FIG. 6(a) depicts such comparison over allowable P_{A} in cOOK scheme under given transmit power constraints. As can be seen, the mutual information rate is either equal to or lower than the simulated bit rate. This is because the approximation used in the theoretical model presented in Sec. IV-B is almost exact for very large input amplitudes (corresponding to small P_{A}). For smaller input amplitudes (corresponding to larger P_{A}), the mutual information rate Equation (22) really provides a lower-bound information rate. Consistent between both simulated and theoretical results, the rate roughly approaches the capacity of cOOK scheme, i.e., [symbol] =1/T_{b}=2P_{A}/T_{c}, as SNR is increased beyond 6 dB. Thus, the rate is primarily governed by the cOOK modulation symbol length L=1/(2P_{A}) which is our main focus. Additionally, as L is increased, the On-pulse amplitude is also increased while keeping its duration T_{c} the same. Thus, it improves the SNR which in turn reduces the BER. This can be seen in FIG. 6(b) which shows the performance of both simulated and theoretical BER calculated using Equation (25) over varying On-pulse probability P_{A} corresponding to the same SNR values. These results are somewhat similar to a conventional modulation scheme where the rate is inversely proportional to BER.

Furthermore, the harvested DC i_{d} arriving at ID for demodulation is simulated in FIG. 6(c), which highlights an ultra-short time-constant τ=21 ps under given input power constraints. Since 5τ≤T_{c}=158 ps, using Equation (26), an ultra-short latency up to L=0.6 ns can be attained at all times with cOOK modulation scheme under given transmit power constraints.

### C. Radar Imaging Performance

We employ high directivity and narrow half-power beamwidth (HPBW) of the transmitter/receiver antennae at the base station to achieve a 16×16 intensity map of the spatial grid space with reasonable resolution. Simulating our cm-scale target of interest (IntRx) to be in the far-field up to a distance of 12.5 m, the circular HPBW=1.9° generates every pixel with at least a spatial resolution of 42×42 cm in xy-coordinates. As mentioned in Sec. V-A, this narrow beam is swept infrequently transmitting a random cOOK modulated signal which refreshes the image to update the spatial position of the IntRx. Considering the detection of a single IntRx in the grid with its corresponding azimuth and elevation, the radar beam is then steered in its direction to obtain a 3D position of the IntRx. We thus focus on this continuous range estimation of the IntRx using the same cOOK modulation scheme without introducing any overhead to simultaneous power and information transfer.

First, we analyze the reflection from the reflecting surface 204 attached to the housing of the IntRx 200. Since the reflection coefficient γ decreases as the incident angle of the specular reflection approach 0°, we compensate for this by introducing a smooth metallic surface on the IntRx housing. This allows for achieving a reflection coefficient γ≥−34 dB at all incident angles. Next, we simulate to listen N=106 time-around windows after every transmitted pulse to estimate the IntRx range. This allows range estimation up to the desired MUR of 12.5 m when symbol length L=5 chips as in Equation (28). Satisfying the desired MUR with a high probability of IntRx detection P_{D} and low false-alarm rate P_{FA}, the receiver output SNR≥14 dB is required using Equation (30) under the given transmit power constraints.

The end-to-end simulations are performed involving; the generation of pseudo-random cOOK modulated time-stamped pulses for transmission, reflection model from non-fluctuating IntRx (target), two-way propagation through frequency-flat THz channel, additive Gaussian noise with distance-dependent power, and a receiver with timestamping for detection. The simulated output SNR compared with the theoretical counterpart for different P_{A} in cOOK, over an IntRx distance between 2.5 and 12.5 m from the base station is shown in FIG. 7(a). From Equation (28), since the MUR is a function of P_{A}, the SNR values corresponding to different P_{A} are clipped up to their respective MUR. As can be seen, when the IntRx is in closer ranges from the base station, the modulation can be customized to improve the information rate while still being able to estimate the range. Similarly, as IntRx moves farthest away from the base station, cOOK is leveraged by reducing P_{A}=0.1 to maintain the required MUR and receiver output SNR≥14 dB.

Lastly, receiver operating characteristic (ROC) curves are plotted in FIG. 7(b) for assumed SNR scenarios without any pulse integration. As mentioned in Sec. V-C, correct range estimation requires echoes received for all M transmitted pulses where we set M=100 to ensure the presence of pulse jitter in the pseudo-random bit sequence with high probability. Thus, the range of IntRx is estimated with high probability of detection P_{D}^{M} using M pulses and listening N time-around windows after each pulse.

### D. STIPT Performance Tradeoff and Optimization

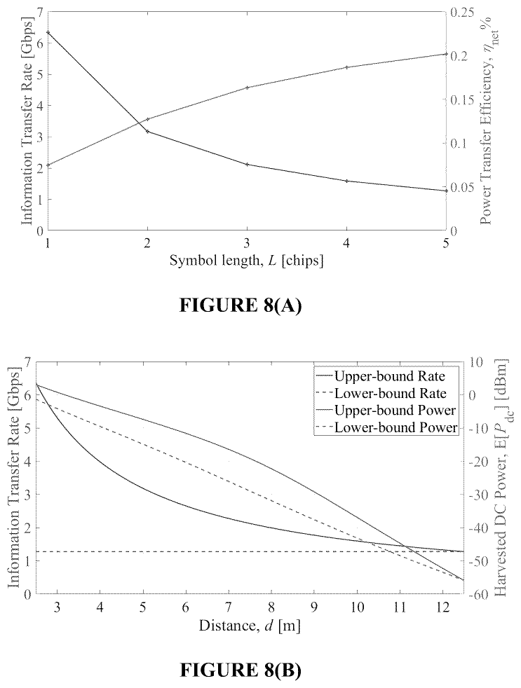

Now we discuss the impact of cOOK modulation scheme with customizable symbol length L on the simulated rate and simulated net harvesting power efficiency ηₙₑₜ using real diode parameters. The ηₙₑₜ is computed with respect to E[P] as in Equation (18) under the same transmit average power E[P]=1 W and PAPR≤10 constraints. There exists a tradeoff between information rate and harvested energy for a choice of transmitted signal waveform studied in [9], [10]. FIG. 8(a) depicts such Rate-Efficiency performance tradeoff in our results over different modulation symbol lengths irrespective of the performance in ranging. As can be seen, the allowable choice of symbol length L can be adjusted as per the requirement to increase either information or power transfer. The distance of IntRx from the base station can be a useful criterion to make such a decision. It can optimize the cOOK to increase the pulse power to guarantee the supply of minimum required energy for IntRx to operate when it moves away from the base station.

In the presented STIIPT approach, the cOOK modulation scheme also estimates range which allows the base station to favor either information rate or harvested energy. However, with MUR also a function of symbol length (or probability of On-pulse), cOOK can be adapted so that the IntRx 200 is detected at all times. Thus, if cOOK is adapted to detect IntRx as it moves away from the base station, the choice of maximum and minimum allowable information rate and average harvested DC power to IntRx also changes, as shown in FIG. 8(b). At a fixed distance, as the harvested energy approaches upper-bound, the information rate approaches lower-bound. Since there is an ever-increasing demand to transmit high-power pulses with an increase in distance between base station and IntRx, the range-dependent cOOK automatically reduces the information rate and favors energy harvesting. Although the harvested energy drops at a higher rate with an increase in distance of the IntRx due to atmospheric losses, cOOK is still an effective modulation scheme for STIIPT that can be customized using results provided in FIG. 8(b) to meet the minimum energy requirements of the IntRx while estimating its range simultaneously. Thus, in STIIPT, the integration of continuous radar ranging (positioning) with simultaneous information and power transfer to IntRx is seamless which also has the potential to be a significant criterion for rate-energy optimization.

### VII. Conclusion

In this disclosure, we presented a novel joint employment of THz band transmission to perform STIIPT from the base station 100 to a battery-limited mobile IntRx 200. For this, we generated a low-complexity single-carrier cOOK modulated waveform and studied its propagation through a THz channel followed by its detection and reflection to/from the IntRx. Under the cOOK modulation scheme designed for STIIPT, we modeled the non-linear rectenna of EH for WPT, presented cOOK demodulation with low-complexity ID for WIT, and devised a mechanism of target (IntRx) range estimation in RI for localization (imaging). The presented theoretical models are validated with simulations and holistic performances are evaluated in terms of harvested power efficiency, achievable information rate, and active radar imaging. It is demonstrated that using the cOOK scheme, symbol length can be customized to increase either energy harvesting or information rate under the transmit average power and peak power constraints. Importantly, when IntRx moves relative to the base station, the range information can be exploited by the cOOK scheme to optimize the R-E tradeoff and guarantee the supply of minimum required harvested energy while maintaining Gbps data rate with nanoseconds latency communication. Therefore, future THz systems for 6G and beyond networks should be designed with key functionalities of imaging for localization and WPT for energy harvesting piggybacked on the THz communications. To this end, this work on STIIPT using a cOOK signaling scheme is the first attempt.

In the embodiment of FIGS. 1-8, the base station has a processing device 122, and the integrated receiver 200 can include a processing device, to perform various functions and operations in accordance with the disclosure. The processing device is typically a general-purpose processor, DSP processor, application specific integrated circuits (ASIC), FPGA circuits or controller. The processing device can be provided with, or be in communication with, one or more of a wide variety of components or subsystems including, for example, a co-processor, register, data processing devices and subsystems, input devices (such as touch screen, keyboard, mouse) for user control or input, monitors for displaying information to the user, and/or storage device(s) such as memory, RAM, ROM, DVD, CD-ROM, analog or digital memory, flash drive, database, computer-readable media, floppy drives/disks, and/or hard drive/disks. All or parts of the system, processes, and/or data utilized in the system of the disclosure can be stored on or read from the storage device(s). The storage device(s) can have stored thereon machine executable instructions for performing the processes of the disclosure. The processing device can execute software that can be stored on the storage device. Unless indicated otherwise, the process is preferably implemented automatically by the processor substantially in real time without delay.

In accordance with the disclosure one embodiment is a base station of a simultaneous THz imaging, information, and power transfer (STIPT) system, transmitting a plurality of pulsed THz waveforms to transfer both power and information to the user-equipment located in the far-field, as well as estimate the range of the user-equipment when the reflected waveform is received at the base station receiver. The base station has an oscillator configured to generate a THz band frequency signal waveform for subsequent modulation. A pulse modulator circuit with a processing device configured to modulate the signal waveform into an On-Off Keying (OOK) modulation scheme followed by a plurality of power amplifier circuits, wherein the pulse modulator circuit, is configured to generate a customizable OOK (cOOK) waveform comprising a plurality of composite symbols, each has a symbol of length L with either one or no On-pulse responsive to the information content for the receiver. A highly directional base station transmitter and receiver antenna configured to transmit and receive the cOOK modulated waveform to/from the user-equipment. A base station receiver with a processing device configured to receive and process the returned signal, said processing device controls the steering of the base station antenna to scan the field-of-view in the user-equipment vicinity.

The number of Off-chips, after one or no On-pulse at the start, is customizable, contributing L−1 to the modulated symbol length. The reflected signal waveform from the user-equipment is compared to the transmitted copy to estimate the radar-like range of the user-equipment using time-of-flight measurements on a plurality of transmitted symbols modulated with cOOK scheme. The pulse modulator is configured to customize the transmitted symbol length to keep the user-equipment within the maximum unambiguous range of the base station, estimated using a plurality of modulated symbols carrying both power and information for the user-equipment. The pulse modulator is configured to customize the transmitted symbol length to increase or decrease the average harvested DC power transferred to the user-equipment, according to its relative position from the base station as determined by the base station receiver processor.

The pulse modulator is configured to customize the transmitted symbol length to increase or decrease the rate of the information transferred to the user-equipment, according to its relative position from the base station as determined by the base station receiver processor. The pulse modulator is configured to customize the transmitted symbol length to increase or decrease the bit-error rate of the information transferred to the user-equipment, according to its relative position from the base station as determined by the base station receiver processor. The pulse modulator is configured to customize the transmitted symbol length to increase or decrease the latency of the information transferred to the user-equipment, according to its relative position from the base station as determined by the base station receiver processor. The co-located transmitter and receiver antenna are responsive to integrated control from the processing device, jointly pointing to plurality of azimuth and elevation gird cells of the field-of-view to obtain the two-dimensional radar image; and wherein the range of the user-equipment present in the field-of-view estimated from the reflected signal adds the third dimension, contributing to its three-dimensional position.

The disclosure further includes user-equipment located in the far-field of a simultaneous THz imaging, information, and power transfer (STIIPT) system, receiving the plurality of pulsed THz waveforms transmitted from the base station. The user equipment has a rectenna-based integrated-receiver (IntRx) configured to jointly harvest energy and decode information from the received signal waveform modulated as above. A reflecting surface attached to the housing of the integrated receiver configured to reflect the incoming signal impinging partially or fully on its surface, back to the base station of claim 1 to estimate range of the user-equipment. The energy is harvested from the incoming signal and transfers power to the information decoder through a circuit with a mix of active and passive components for power management or regulation. The equipment decodes the information from the incoming signal amplitude variation in one or more contiguous cOOK modulated symbols, independently of the amount of energy harvested by the energy harvester. A high-gain receiver antenna configured to receive a narrow beam of incoming signal from the base station within its vicinity, and wherein the received signal is absorbed by the energy harvester in the presence or absence of low-noise amplifier circuit.

As used herein, when an element or feature is described as being “configured,” that element or feature is structurally arranged or formed to accomplish the stated purpose. As used with respect to a processing device, the term “configured” means that the processing device is structurally arranged or ordered to accomplish the stated purpose or task.

The following references are hereby incorporated by reference.
[1] H. Sarieddeen, M.-S. Alouini and T. Y. Al-Naffouri, “An Overview of Signal Processing Techniques for Terahertz Communications,” in Proc. IEEE, vol. 109, no. 10, pp. 1628-1665, October 2021.
[2] T. S. Rappaport et al., “Wireless Communications and Applications Above 100 GHz: Opportunities and Challenges for 6G and Beyond,” in IEEE Access, vol. 7, pp. 78729-78757, 2019.
[3] Z. Chen et al., “Terahertz Wireless Communications for 2030 and Beyond: A Cutting-Edge Frontier,” in IEEE Commun. Mag., vol. 59, no. 11, pp. 66-72, November 2021.
[4] S. Mizojiri and K. Shimamura, “Recent Progress of Wireless Power Transfer via Sub-THz wave,” 2019 IEEE Asia-Pacific Microwave Conf. (APMC), 2019, pp. 705-707.
[5] I. Mehdi, J. V. Siles, C. Lee and E. Schlecht, “THz Diode Technology: Status, Prospects, and Applications,” in Proc. IEEE, vol. 105, no. 6, pp. 990-1007, June 2017.
[6] G. Valugis, A. Lisauskas, H. Yuan, W. Knap and H. G. Roskos, “Roadmap of Terahertz Imaging 2021,” in Sensors, vol. 21, no. 12: 4092, 2021.
[7] T. J. Lee, P. Patil, C. Y. Hu, M. Rajabi, S. Farsi and D. M. M.-P. Schreurs, “Design of Efficient Rectifier for Low-power Wireless Energy Harvesting at 2.45 GHz,” 2015 IEEE Radio and Wireless Symposium (RWS), 2015, pp. 47-49.
[8] B. Clerckx and E. Bayguzina, “Waveform Design for Wireless Power Transfer,” in IEEE Trans. Sig. Process., vol. 64, no. 23, pp. 6313-6328, December 2016.
[9] B. Clerckx, “Wireless Information and Power Transfer: Nonlinearity, Waveform Design, and Rate-Energy Tradeoff,” in IEEE Trans. Sig. Process., vol. 66, no. 4, pp. 847-862, February 2018.
[10] X. Zhou, R. Zhang and C. K. Ho, “Wireless Information and Power Transfer: Architecture Design and Rate-Energy Tradeoff,” in IEEE Trans. Commun., vol. 61, no. 11, pp. 4754-4767, November 2013.
[11] D. Kim, H. Lee, K. Kim and J. Lee, “Dual Amplitude Shift Keying with Double Half-Wave Rectifier for SWIPT,” in IEEE Wireless Commun. Letters, vol. 8, no. 4, pp. 1020-1023, August 2019.
[12] M. Varasteh, B. Rassouli and B. Clerckx, “On Capacity-Achieving Distributions for Complex AWGN Channels Under Nonlinear Power Constraints and Their Applications to SWIPT,” in IEEE Trans. Info. Theory, vol. 66, no. 10, pp. 6488-6508, October 2020.
[13] J. Kim and B. Clerckx, “Wireless Information and Power Transfer for IoT: Pulse Position Modulation, Integrated Receiver, and Experimental Validation,” in IEEE Internet Things J., vol. 9, no. 14, pp. 12378-12394, July, 2022.
[14] J. M. Jornet and I. F. Akyildiz, “Femtosecond-Long Pulse-based Modulation for Terahertz Band Communication in Nanonetworks,” in IEEE Trans. Commun., vol. 62, no. 5, pp. 1742-1754, May 2014.
[15] Y. Pan, K. Wang, C. Pan, H. Zhu and J. Wang, “Self-Sustainable Reconfigurable Intelligent Surface Aided Simultaneous Terahertz Information and Power Transfer (STIPT),” in IEEE Trans. Wireless Commun., vol. 21, no. 7, pp. 5420-5434, July 2022.
[16] C. De Lima et al., “Convergent Communication, Sensing and Localization in 6G Systems: An Overview of Technologies, Opportunities and Challenges,” in IEEE Access, vol. 9, pp. 26902-26925, 2021.
[17] A. R. Chiriyath, B. Paul and D. W. Bliss, “Radar-Communications Convergence: Coexistence, Cooperation, and Co-Design,” in IEEE Trans. Cognitive Commun. Net., vol. 3, no. 1, pp. 1-12, March 2017.
[18] M. Aladsani, A. Alkhateeb and G. C. Trichopoulos, “Leveraging mmWave Imaging and Communications for Simultaneous Localization and Mapping,” 2019 IEEE Int. Conf. on Acoustics, Speech, and Sig. Process. (ICASSP), 2019, pp. 4539-4543.
[19] J. M. Jornet and I. F. Akyildiz, “Channel Modeling and Capacity Analysis for Electromagnetic Wireless Nanonetworks in the Terahertz Band,” in IEEE Trans. Wireless Commun., vol. 10, no. 10, pp. 3211-3221, October 2011.
[20] I. E. Gordon et al., “The HITRAN2020 Molecular Spectroscopic Database,” in J. of Quantitative Spectroscopy and Radiative Transfer, vol. 277, no. 107949, 2022.
[21] B. Clerckx and E. Bayguzina, “Low-Complexity Adaptive Multisine Waveform Design for Wireless Power Transfer,” in IEEE Antennas Wireless Propag. Letters, vol. 16, pp. 2207-2210, 2017.
[22] S. Dolinar, D. Divsalar, J. Hamkins, and F. Pollara, “Capacity of Pulse-Position Modulation (PPM) on Gaussian and Webb Channels,” No. JPL-TMO-PR-42-142. 2000.
[23] P. Rieger, “Range Ambiguity Resolution Technique Applying Pulse-Position Modulation in Time-of-Flight Scanning Lidar Applications,” in Optical Engr., vol. 53, no. 6, p. 61614, 2014.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

1. A base station for a wireless communication system in communication with an integrated receiver having a battery or not, comprising:
a base station transmitter configured to transmit a Terahertz signal waveform over a base station transmitter antenna;
an On-Off Keying modulator configured to generate the Terahertz signal according to an On-Off Keying scheme; and
a base station processing device configured to control transmission of the Terahertz signal over said base station transmitter, said base station configured to determine a distance of the integrated receiver from said base station, adapt the Terahertz signal waveform based on the determined distance using said On-Off keying modulator to adjust energy harvesting and information rate of said Terahertz signal, said base station processing device processing the Terahertz signal for simultaneous active radar imaging, wireless information transfer, and wireless power transfer.

2. The base station of claim 1, further comprising a base station receiver, wherein said Terahertz signal is reflected by the integrated receiver to said base station receiver and said base station processing device determines the distance based on the reflected Terahertz signal.

3. The base station of claim 1, wherein said base station processing device optimizes information rate, bit-error probability, and latency in a Terahertz communication channel.

4. The base station of claim 1, wherein said base station processing device adapts the Terahertz signal waveform to an achievable information rate, bit-error probability and latency.

5. The base station of claim 1, said base station processing device continuously determining the distance of the integrated receiver from said base station.

6. The base station of claim 1, the energy harvesting charging the battery of the integrated receiver if the battery is used in it.

7. The base station of claim 1, said base station processing device reduces the information rate in favor of energy harvesting as the distance between the integrated receiver and said base station increases.

8. A base station of a simultaneous Terahertz (THz) imaging, information, and power transfer (STIIPT) system, communicating with user-equipment, comprising:
a transmitter configured to produce a customizable On-Off Keying (cOOK) THz band waveform;
a base station transmitter antenna configured to transmit the cOOK modulated THz band waveform to the user-equipment to simultaneously transfer both power and information to the user-equipment; and
a base station receiver with a receiver antenna and a processing device configured to receive a returned signal waveform reflected from the user equipment and process the returned signal waveform, said processing device controls steering of the base station transmitter antenna and receiver antenna to scan a field-of-view in front of the base station.

9. The base station of claim 8, wherein said cOOK THz band waveform is composed of two basic signals representing information bits 1 and 0, each signal having length of L time-chips where in the first time-chip a sinusoidal pulse is placed when bit 1 is transmitted, or there is no sinusoidal pulse when bit 0 is transmitted to the receiver, and said base station transmitter antenna transmits the cOOK modulated THz band waveform with a half-power beamwidth smaller than 2°.

10. The base station of claim 8, wherein the number of Off-chips, after one or no On-pulse at the start, is customizable, contributing L−1 time-chips to the modulated symbol length.

11. The base station of claim 8, wherein the returned signal waveform from the user-equipment is compared to the transmitted copy for timestamping to estimate radar-like range of the user-equipment using time-of-flight measurements on a plurality of transmitted signals modulated with cOOK scheme.

12. The base station of claim 8, wherein said transmitter is configured to customize transmitted symbol length to keep the user-equipment within the maximum unambiguous range of the base station, estimated using a plurality of modulated signals carrying both power and information for the user-equipment.

13. The base station of claim 8, wherein the transmitter is configured to customize the transmitted symbol length to increase or decrease the average harvested DC power transferred to the user-equipment, according to its relative position from the base station as determined by the base station receiver processor.

14. The base station of claim 8, wherein the transmitter is configured to customize the transmitted symbol length to increase or decrease the rate of the information transferred to the user-equipment, according to its relative position from the base station as determined by the base station receiver processor.

15. The base station of claim 8, wherein the transmitter is configured to customize the transmitted symbol length to increase or decrease the bit-error rate of the information transferred to the user-equipment, according to its relative position from the base station as determined by the base station receiver processor.

16. The base station of claim 8, wherein the transmitter is configured to customize the transmitted symbol length to increase or decrease the latency of the information transferred to the user-equipment, according to its relative position from the base station as determined by the base station receiver processor.

17. The base station of claim 8, wherein the transmitter antenna and receiver antenna are co-located and responsive to integrated control from the processing device, jointly scanning in the azimuth and elevation of the 2D grid space to create a two-dimensional pixel image indicating the presence of user-equipment; and wherein the range of the user-equipment, localized in 2D space, is estimated from the reflected signal.

18. A user-equipment located in the far-field of a simultaneous THz imaging, information, and power transfer (STIIPT) system, receiving the plurality of pulsed THz waveforms transmitted from the base station of claim 1, comprising:
a rectenna-based integrated-receiver (IntRx) configured to jointly harvest energy and decode information from the received signal waveform modulated; and
a reflecting surface attached to the housing of the integrated receiver configured to reflect the incoming signal impinging partially or fully on its surface, back to the base station to estimate range of the user-equipment.

19. The user-equipment of claim 18, wherein energy is harvested from the incoming signal and transfers power to the information decoder through a circuit for power management or regulation.

20. The user-equipment of claim 18, which decodes the information from the incoming signal amplitude variation in one or more contiguous cOOK modulated symbols, independently of the amount of energy harvested by the energy harvester.

21. The user equipment of claim 18, further comprising a receiver antenna configured to receive a narrow beam of incoming signal from the base station within its vicinity, and wherein the received signal is absorbed by the energy harvester through a matching network.
